(19) United States
(12) Patent Application Publication
(10) Pub. No.: US 2014/0069154 A1
(43) Pub. Date: Mar. 13, 2014

(54) REVERSIBLE DOOR AND MULTIPOINT LOCK

(71) Applicant: Moshe Dolev, Raanana (IL)

(72) Inventor: Moshe Dolev, Raanana (IL)

(21) Appl. No.: 13/609,637

(22) Filed: Sep. 11, 2012

(51) Int. Cl. E05B 59/00; E05B 63/08; E05B 21/06

(52) U.S. Cl. 70/108; 70/490

(57) ABSTRACT

A lock assembly including a cylinder lock including a plug and cam which are both rotatable about a longitudinal axis of the cylinder lock, and a latch and a rotatable deadbolt both operatively linked to the cam, wherein rotation of the cam about the longitudinal axis causes two actions: rotation of the deadbolt about a rotational axis different from the longitudinal axis to move the deadbolt to an unlocked position, and retraction of the latch to an unlatched position.

### FIELD OF THE INVENTION

The present invention relates generally to doors and locks, and particularly to a reversible door and lock.

### BACKGROUND OF THE INVENTION

Mortise locks are typically designed to fit into an opening provided in the edge of a door opposite the edge that is hinged to the door frame. The lock generally includes a latch movable between an extended position, in which it projects beyond the edge of the door into an opening in the door frame to latch the door closed, and a retracted position, in which it permits opening of the door. Mortise locks also typically include a deadbolt that is movable between an extended position, in which it projects beyond the edge of the door into an opening in the door frame to lock the door, and a retracted position, in which it permits opening of the door. Mortise locks are typically configured so that a door knob or handle can be turned to retract the latch, whereas the outer side is operated by inserting an authorized key into a cylinder lock and turning the plug of the cylinder lock to retract the deadbolt and the latch.

A door may be hinged to a door frame along its left side edge or its right side edge. Reversible door latches usable on both right-handed and left-handed doors are well known. One kind of reversible latch achieves reversibility by rotating the spring latch 180° about its axis; another kind turns the housing upside down.

Another kind of latch achieves reversibility by using two latch bolts, one extendible through one side of the housing for use on right-handed doors and the other extendible through the other side of the housing for use on left-handed doors. All of the above methods are cumbersome and time-consuming.

### SUMMARY OF THE INVENTION

The present invention seeks to provide an improved reversible door and lock, as described in more detail further below.

There is thus provided in accordance with an embodiment of the present invention a lock assembly including a cylinder lock including a plug and cam which are both rotatable about a longitudinal axis of the cylinder lock, and a latch and a rotatable deadbolt both operatively linked to the cam, wherein rotation of the cam about the longitudinal axis causes two actions: rotation of the deadbolt about a rotational axis different from the longitudinal axis to move the deadbolt to an unlocked position, and retraction of the latch to an unlatched position.

### BRIEF DESCRIPTION OF THE DRAWINGS

The present invention will be understood and appreciated more fully from the following detailed description, taken in conjunction with the drawings in which:

FIG. 1 is a simplified pictorial illustration of a door with a lock, constructed and operative in accordance with a non-limiting embodiment of the present invention;

FIG. 1A is a simplified enlarged illustration of the lock (external view), showing a double door handle, two latches and a rotatable deadbolt, in accordance with a non-limiting embodiment of the present invention;

FIG. 1B is a simplified enlarged illustration of the door, showing the upper part of the door with the possibility of installing therein a lower adjustable door insert assembly or upper door insert assembly, in accordance with a non-limiting embodiment of the present invention;

FIG. 1C is a simplified enlarged illustration of the door, showing the lower part of the door with the adjustable lower door insert assembly installed therein (as described further below, after turning the door upside down, the upper door insert assembly can be inserted therein because the lower part of the door becomes the upper part), in accordance with a non-limiting embodiment of the present invention;

FIG. 2 is a simplified pictorial illustration of the outer door skin, having hinge-side and latch-side stiles bent from a door skin panel, in accordance with a non-limiting embodiment of the present invention;

FIGS. 2A and 2B are simplified enlarged illustrations of the upper and lower parts of the hinge-side stile, in accordance with a non-limiting embodiment of the present invention;

FIGS. 3A and 3B are simplified pictorial and end-view illustrations, respectively, of the adjustable lower door insert assembly, in accordance with a non-limiting embodiment of the present invention;

FIG. 4 is a simplified pictorial illustration of the double door handle operatively connected to the two latches, in accordance with a non-limiting embodiment of the present invention;

FIGS. 5 and 5A are simplified perspective and enlarged illustrations, respectively, of an inner escutcheon in which there is a biasing assembly of the door handle spindle of the lock, in accordance with a non-limiting embodiment of the present invention;

FIGS. 6 and 6A are simplified perspective and enlarged illustrations, respectively, of a complementary outer escutcheon, corresponding to FIGS. 5 and 5A;

FIGS. 7 and 7A are simplified perspective and enlarged illustrations, respectively, of a cylinder lock, having an internal knob and an external key-operated plug, and operative to simultaneously rotate a deadbolt and rotate a pair of latch actuators, in accordance with a non-limiting embodiment of the present invention;

FIGS. 8 and 8A are simplified perspective and enlarged illustrations, respectively, of the rotatable deadbolt operatively connected to rotate a pair of auxiliary deadbolts, in accordance with a non-limiting embodiment of the present invention;

FIGS. 8B and 8C are simplified illustrations of the deadbolt in respective unlocked and locked positions with respect to a bolt receptacle, showing sloped side faces of the deadbolt, in accordance with a non-limiting embodiment of the present invention;

FIG. 8D is a simplified illustration of a deadbolt which does not have sloped side faces, and which has rotated into a blocked position after the deadbolt has continued to rotate after unlatching the latch;

FIGS. 9A and 9B are simplified perspective illustrations of the latch actuators and latch throwers, linear cams and cam followers, in accordance with a non-limiting embodiment of the present invention;

FIG. 10 is a simplified enlarged illustration of the latch thrower and linkage mechanism for the latch;

FIG. 10A is a simplified illustration of turning the upper arm of the latch thrower counterclockwise to retract the latch;

FIG. 10B is a simplified illustration of turning the lower arm of the latch thrower clockwise to retract the latch;

FIG. 10C is a simplified illustration of the latch thrower in a middle, neutral position, with the latch in an extended, latched position;

FIG. 10D is a simplified exploded illustration of lower and upper arms of the latch thrower mounted on a hub;

FIGS. 11A and 11B are simplified perspective illustrations of the lock assembly, respectively with and without a casing, in accordance with a non-limiting embodiment of the present invention, showing the inner and outer housings of the cylinder lock, deadbolt, latches and auxiliary deadbolts;

FIG. 12 is a simplified perspective illustration of the lock assembly of FIGS. 11A and 11B, assembled with an inner door construction, in accordance with a non-limiting embodiment of the present invention; and

FIGS. 13 and 13A are simplified perspective and enlarged illustrations, respectively, of the deadbolt and auxiliary deadbolts that provide stress distribution interfacing with hinge assemblies and locking receptacles on the hinge side and latch side of the door, respectively, in accordance with a non-limiting embodiment of the present invention.

### DETAILED DESCRIPTION OF EMBODIMENTS

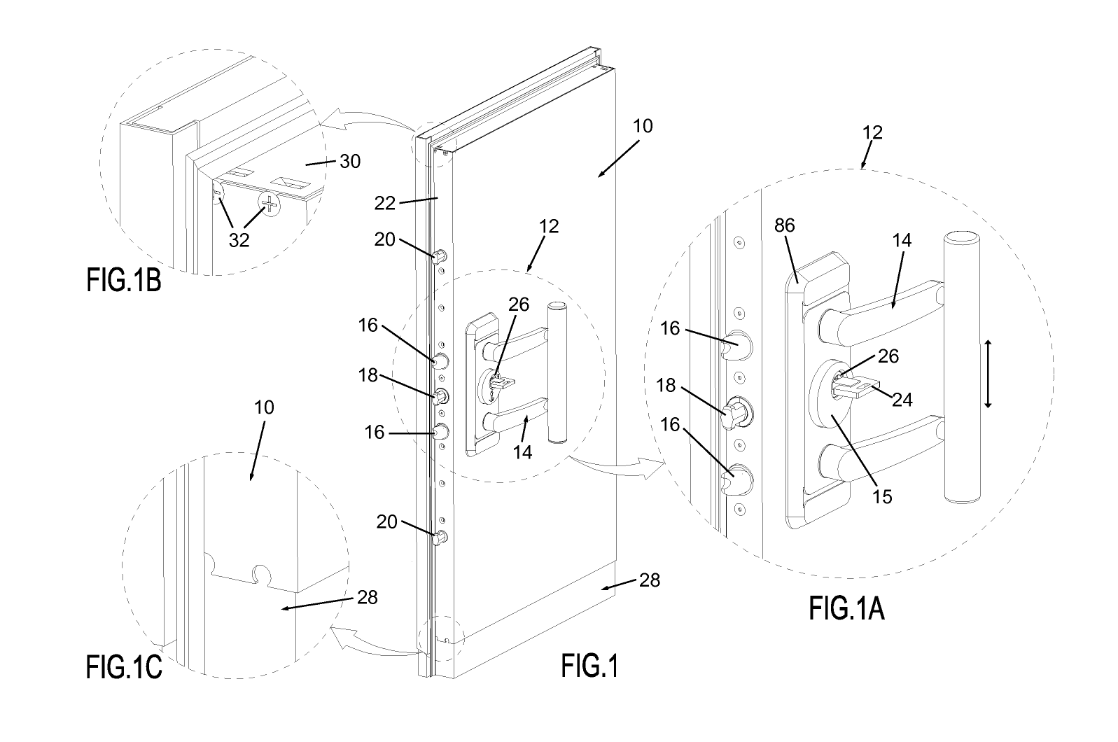

Reference is now made to FIGS. 1-1C, which illustrate a door 10 with a lock 12, constructed and operative in accordance with a non-limiting embodiment of the present invention.

Lock 12 includes a double door handle 14, which can be turned up or down to operate two latches 16 on the latch side 22 of door 10. Latches 16, a central rotatable deadbolt 18 and one or more auxiliary deadbolts 20 are operated by a key 24 inserted in (typically the external side of) a cylinder lock 26. Alternatively, the invention can be carried out with a single door handle, which can be turned up or down to operate a single latch.

Lock 12 is symmetrically installed in door 10; a center of lock 12 is equidistant to the top and bottom of the door without the adjustable telescopic lower door insert 28 (described later). This allows for both left sided and right sided installation of door 10 by simply turning the door upside down, without having to re-install or make any modifications to lock 12. For example, in the illustration, door 10 is shown for right sided installation; that is, while looking at the door from the outside, the hinge side is on the right and the door is opened inwardly. Door 10 can be turned upside down for left sided installation, wherein the hinge side is on the left. Since lock 12 is symmetrically installed in door 10 with respect to the top and bottom of the door (without the adjustable telescopic lower door insert 28), lock 12 remains in its same central position on the door 10, even after turning the door upside down. An outer housing 15 of the lock assembly, as well as the inner housing, remain in its same central position on the door 10. As mentioned before, door handle 14 operates in both directions, up and down.

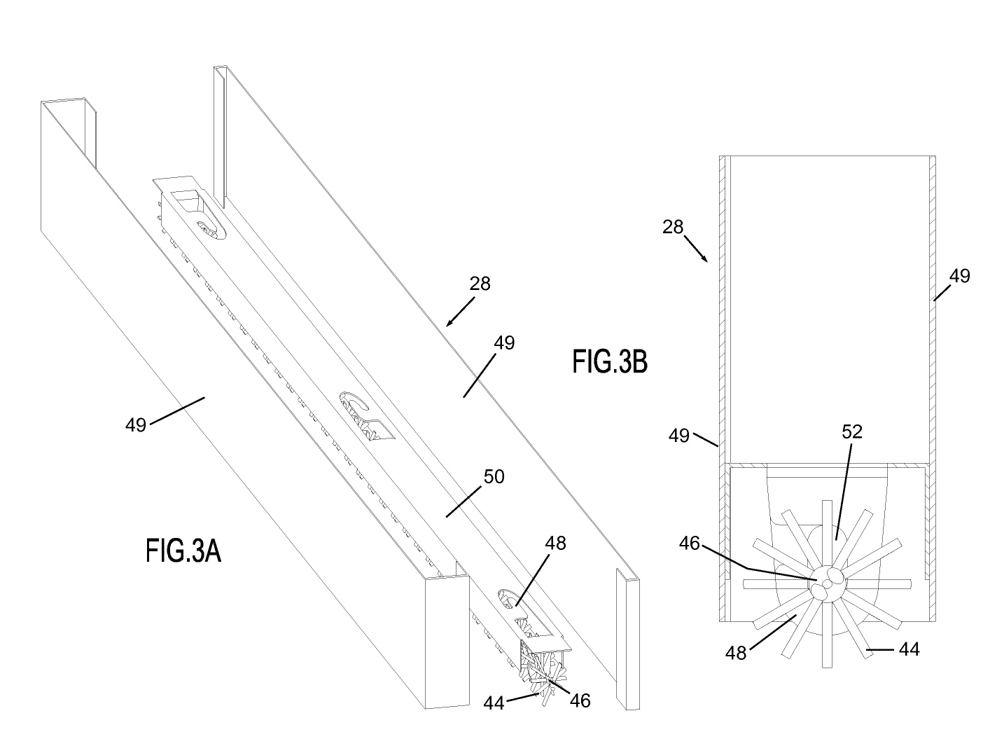

FIG. 1C illustrates the lower part of door 10, showing the external part of an adjustable lower door insert assembly 28 installed therein. This will be explained more in detail with reference to FIGS. 3A and 3B. FIG. 1B shows the upper part of door 10, which has an upper insert 30 that closes the hollow door construction, attached with fasteners 32. Upper insert 30 may be easily removed so that if door 10 is turned upside down, door insert assembly 28 can be transferred from the former bottom of the door (which is now the top) and re-installed in the current bottom of the door (which was previously the top). Of course, upper insert 30 would then be re-installed in the new top of the door.

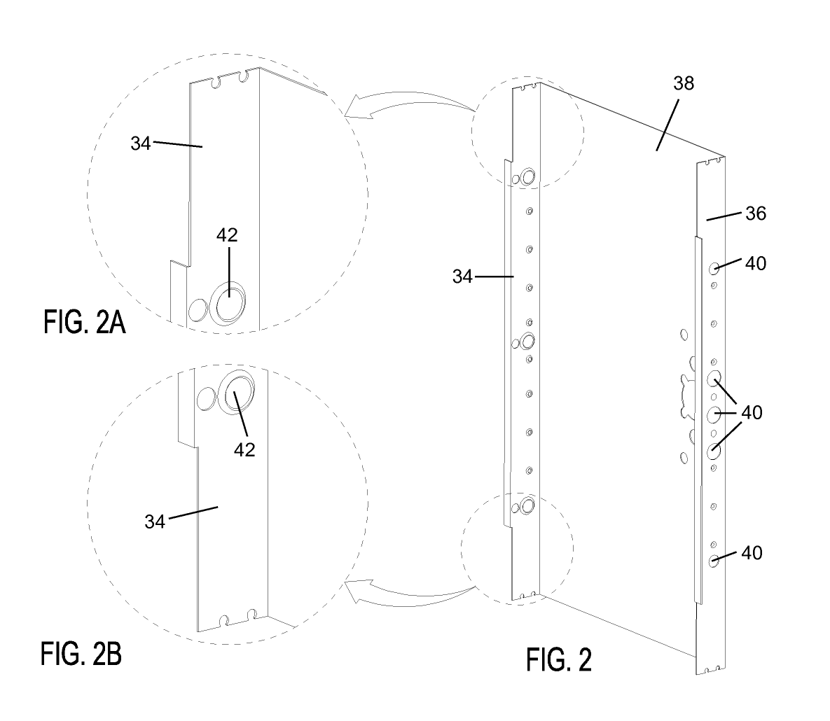

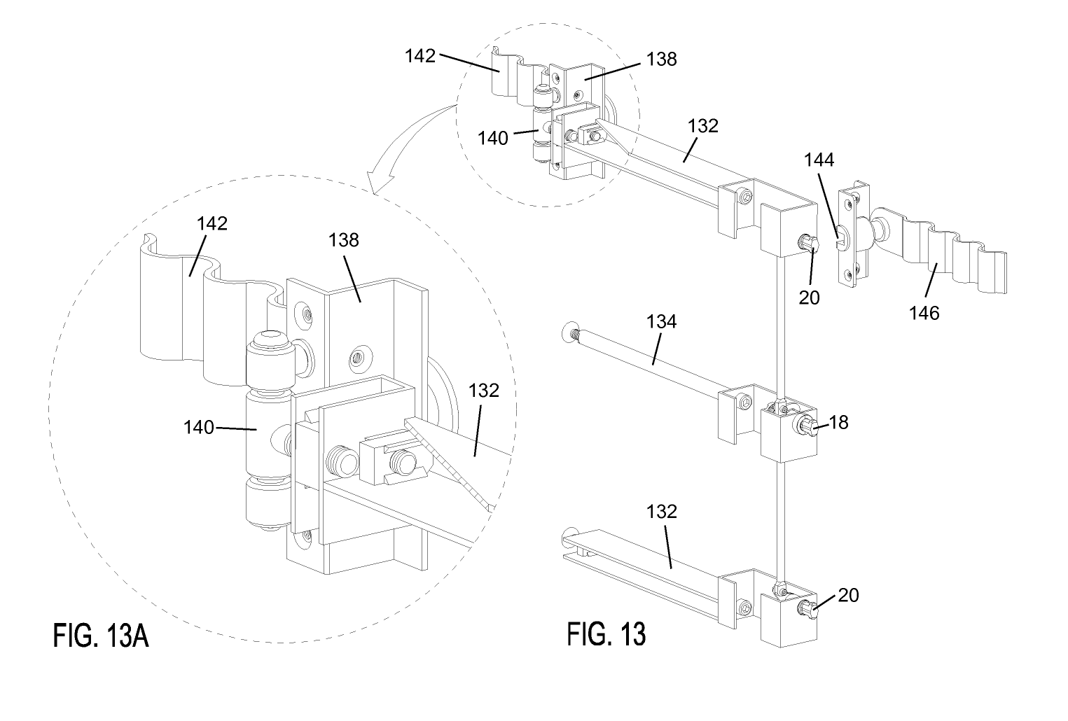

Reference is now made to FIGS. 2-2B, which illustrate the basic door skin construction. Hinge-side and latch-side stiles 34 and 36, respectively, may be bent from a door skin panel 38, made of sheet metal, for example, or other suitable materials. Latch-side stile 36 has appropriately sized apertures 40 positioned to be aligned with the latches and deadbolts. Similarly, hinge-side stile 34 has appropriate apertures 42 to accommodate rails (not shown here, but shown in FIG. 13) to pass therethrough. The hinge-side stiles 34 and apertures 42 are arranged symmetrically with the top and bottom of the door panel so that the door can be turned upside down for both left-handed and right-handed installation, as described above.

Reference is now made to FIGS. 3A and 3B, which illustrate the lower door insert assembly 28. Lower door insert assembly 28 has a set of bristles 44 mounted on a rod 46. Bristles 44 may be soft or hard, stiff or flexible, depending on the application. The assembly may alternatively use other elements than bristles, such as brushes or wipers. Rod 46 is supported at opposite ends thereof in two or more bearing supports 48 (three are shown). The bearing supports 48 may be simply constructed as tongue-shaped supports cut or punched out of a housing 50 and bent down. Housing 50 is secured in sides 49 of lower door insert assembly 28. Rod 46 sits in an elongate opening 52 formed in each of the bearing supports 48. In the illustrated embodiment, opening 52 is open at the side, but this is not necessary. Opening 52 is elongate in the vertical position (vertical in the sense of the door installation). This allows for the bristles 44 to move up and down as the door is opened or closed, so the door insert assembly 28 easily goes over any obstructions or imperfections on the floor, all the while maintaining contact with the floor. The open sides of elongate openings 52 preferably face in alternating directions (towards the inside of the door alternating with towards the outside of the door). In this manner, rod 46 will stay in the supports and not come out during use.

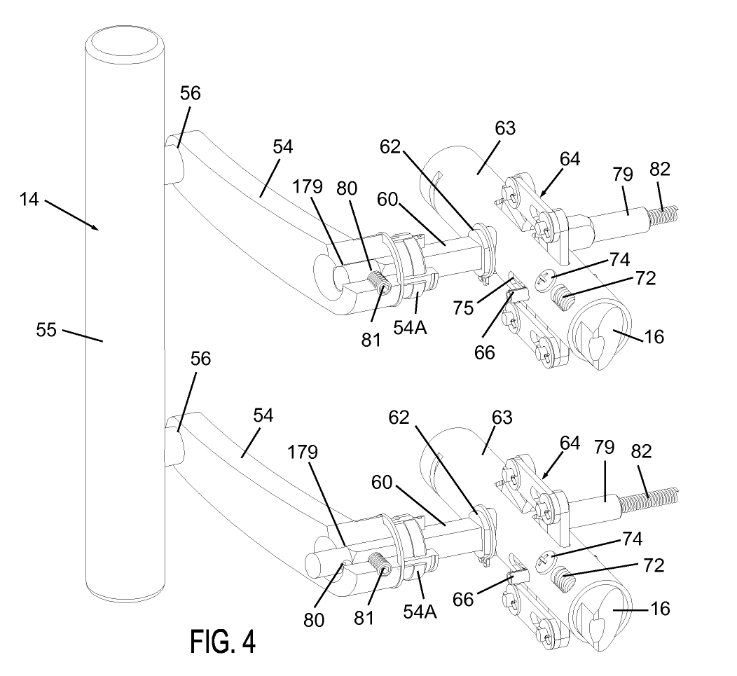

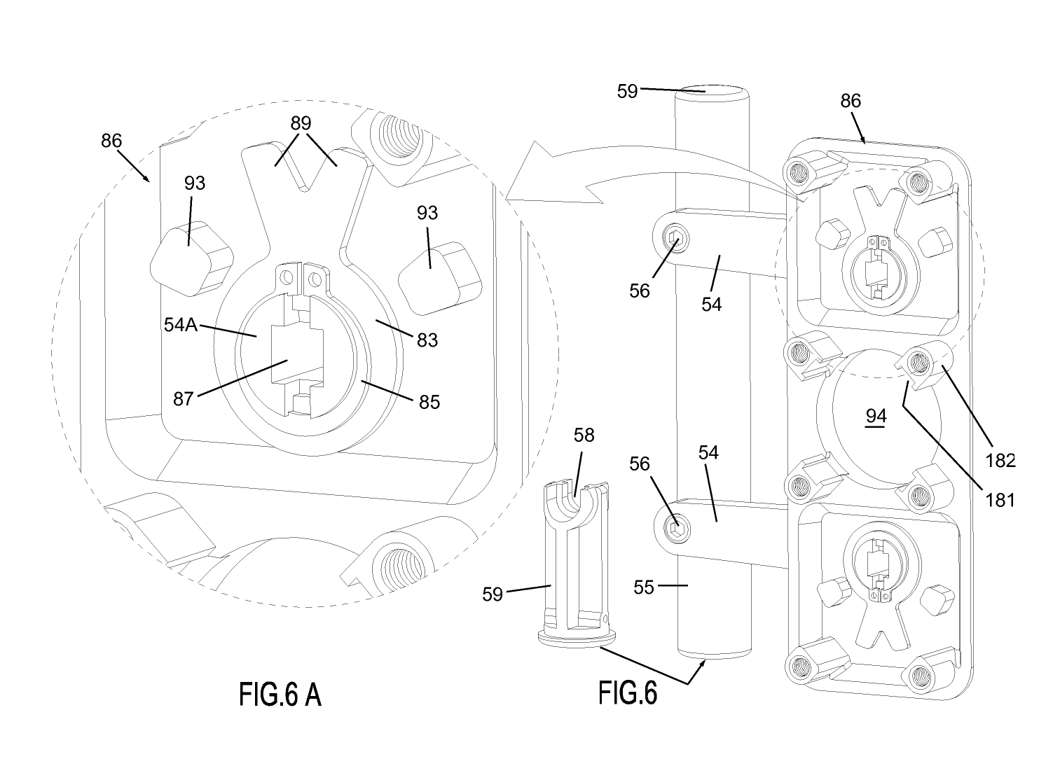

Reference is now made to FIG. 4, which illustrates more detail of the double door handle 14 operatively connected to the two latches 16. Handle 14 includes two horizontal handles 54 to which a vertical handle 55 is pivotally connected at pivots 56. As seen in FIG. 6, pivot 56 may include a pin journaled in an open-ended round bearing support 58 located at the end of an insert 59 which may be inserted into either end of vertical handle 55.

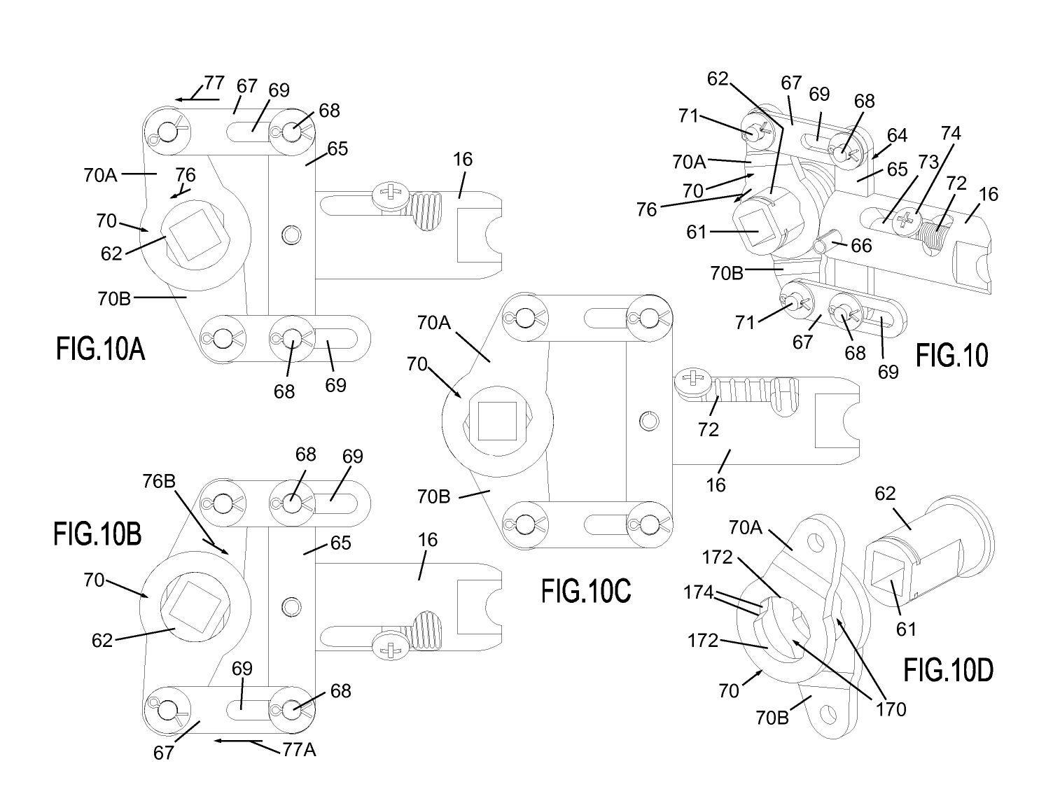

Each handle 54 (FIG. 4) is secured to a spindle 60 (FIG. 4) which passes through a non-round spindle hole 61 (FIG. 10) of a hub 62 of the lock. Each spring latch 16 is arranged to be moved in and out of a (e.g., cylindrical) housing 63 (FIG. 4), by means of a linkage mechanism 64, which is now described with reference to FIG. 10.

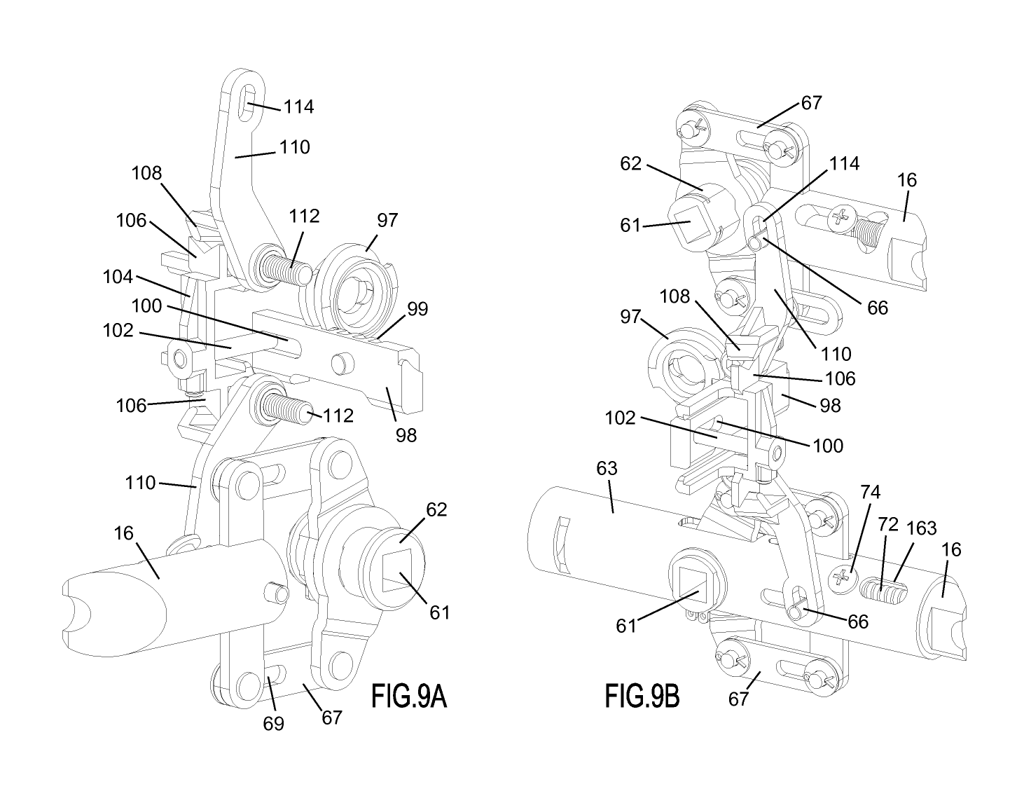

Linkage mechanism 64 includes a first link 65 secured by a pin 66 (of any shape) to latch 16. Two second links 67 are pivotally attached to opposite ends of first link 65 by pinned connections 68, each of which can translate in an elongate cutout 69 formed in second link 67. The opposite ends of second links 67 are pivotally attached by pinned connections 71 to opposite arms 70A and 70B of a latch thrower 70, which turns with and extends from hub 62 (also seen in the exploded view of FIG. 10D). Latch 16 includes a biasing device 72 (such as a coil spring), which is positioned in a groove 73 formed in latch 16. The end of biasing device 72 opposite to the slanted face of latch 16 abuts against a fastener 74, which is secured to housing 63 (FIG. 4). Biasing device 72 may be assembled in its place through an aperture 163 formed in housing 63 (FIG. 9B). Pin 66 is arranged to move in a groove 75 formed in housing 63 (FIG. 4).

As seen best in FIG. 10D, arms 70A and 70B are each formed with an aperture 170 that has upper and lower circular portions 172, each of which have inwardly sloping straight portions 174.

FIG. 10C illustrates latch thrower 70 in a middle, neutral position, with latch 16 in an extended, latched position; biasing device 72 is not compressed. Upon turning hub 62 and latch thrower 70 counterclockwise in the sense of FIGS. 10 and 10A, as indicated by arrow 76 in FIGS. 10 and 10A (by moving vertical handle 55 downwards in the sense of FIG. 4), the upper second link 67 moves left, as indicated by arrow 77 in FIG. 10A. Since the pinned connection 68 is already at the right end of cutout 69, the leftward movement of second link 67 pulls first link 65 also to the left, thereby retracting latch 16 into housing 63 (FIG. 4). The lower pinned connection 68 freely travels to the left in its cutout 69.

By comparing FIGS. 10A, 10C and 10D, one sees that upon turning hub 62 and latch thrower 70 counterclockwise, hub 62 immediately pushes against the upper left inwardly sloping straight portion 174 of arm 70A and the lower right inwardly sloping straight portion 174 of arm 70A. However, hub 62 first turns slightly along the circular portions 172 of arm 70B before hub 62 pushes against the upper left inwardly sloping straight portion 174 of arm 70B and the lower right inwardly sloping straight portion 174 of arm 70B. This ensures that turning hub 62 and latch thrower 70 counterclockwise will not move the lower pinned connection 68 against the right limit of its cutout 69, which would undesirably act against unlatching the latch 16.

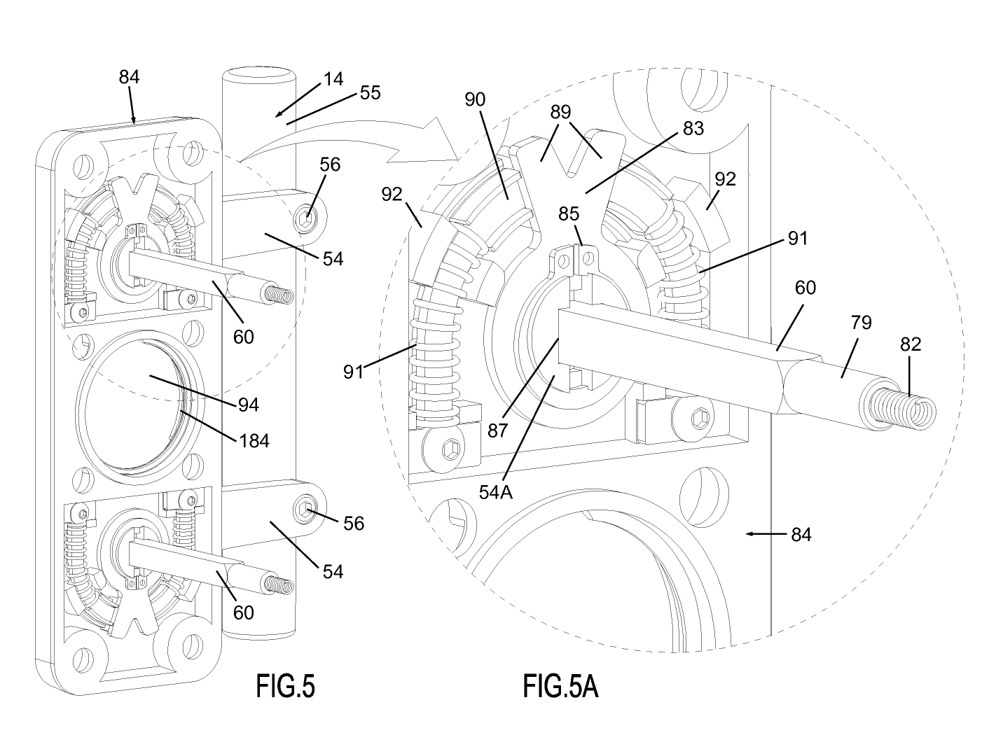

Upon retraction of latch 16 into housing 63, pin 66 moves to the left end of groove 75 of cylindrical housing 63 (FIG. 4). The inward retraction of latch 16 compresses biasing device 72, as seen in FIG. 10A. Upon release of the handle (which has its own independent biasing devices 91, shown in FIGS. 5 and 5A), biasing device 72 urges latch 16 back out of housing 63. It is noted that if the door is turned upside down, the mechanism works the same way: the former lower pinned connection 68 becomes the upper pinned connection and moves the latch thrower 70, whereas the former upper pinned connection 68 is now the lower one which is free to travel in its cutout 69 and does not interfere with movement of latch 16.

It should be noted that latch thrower 70 retracts latch 16 with a rotation of only about 30° and works in both directions. This is in contrast to prior art mechanisms which need a rotation of about 90° to retract the latch. The present invention achieves a smaller arc of rotation due to the leverage arm and moment provided by the structure of linkage mechanism 64.

Conversely, upon turning hub 62 and latch thrower 70 clockwise in the sense of FIG. 10B (from the initial position of FIG. 10C), as indicated by arrow 76B in FIG. 10B (by moving vertical handle 55 upwards in the sense of FIG. 4), the lower second link 67 moves left, as indicated by arrow 77A in FIG. 10B. Since the pinned connection 68 is already at the right end of cutout 69, the leftward movement of the lower second link 67 pulls first link 65 also to the left, thereby retracting latch 16 into housing 63 (FIG. 4). The upper pinned connection 68 freely travels to the left in its cutout 69

Referring again to FIG. 4, it is seen that one end of spindle 60 is secured to handle 54 with a set screw 81. The opposite end of spindle 60 terminates in a round portion 79 and is biased at its end by a biasing device 82, such as a coil spring. Spindle 60 may be adjusted to one of two positions. In one position (shown for convenience in the upper handle of FIG. 4), spindle 60 is operatively connected to both inner handle 54 (FIGS. 4 and 5) and outer handle 54 (FIG. 6). In this position, the set screw 81 is tightened against a depression 80 formed in spindle 60. In another position (shown for convenience in the lower handle of FIG. 4), spindle 60 is moved linearly so that it is no longer in operative connection with outer handle 54. This is now explained more in detail with reference to FIGS. 5 and 5A.

Reference is now made to FIGS. 5-6A, which illustrate inner and outer escutcheons 84 and 86, respectively. In FIG. 5A, spindle 60 passes through a non-round (square) opening 87 formed in a portion 54A of the handle. The far end of spindle 60 can also pass into the non-round opening 87 of portion 54A of the handle 54 in the outer escutcheon 86, in FIG. 6A. If spindle 60 is moved to its outermost position in the inner handle 54 (shown in the upper handle of FIG. 4), then the square part of spindle 60 enters opening 87 of the portion 54A of the handle 54 in the outer escutcheon 86 (thereby compressing spring 82), and spindle 60 is operatively connected to both inner handle 54 (FIGS. 4 and 5) and outer handle 54 (FIG. 6). If spindle 60 is moved to its innermost position in the inner handle 54 (shown in the lower handle of FIG. 4), then the round portion 79 of spindle 60 enters opening 87 of portion 54A of the handle 54 in the outer escutcheon 86. Spring 82 provides the spring force that pushes spindle 60 to this position. A shoulder stop 179 is provided in handle 54 to limit the travel of spindle 60; in the lower handle 54 in FIG. 4, it is seen that spindle 60 has reached this shoulder stop 179. The round portion 79 of spindle 60 simply turns freely in opening 87 of the outer handle. Thus spindle 60 is operatively connected only to the inner handle 54 (FIGS. 4 and 5) and not to the outer handle 54 (FIG. 6).

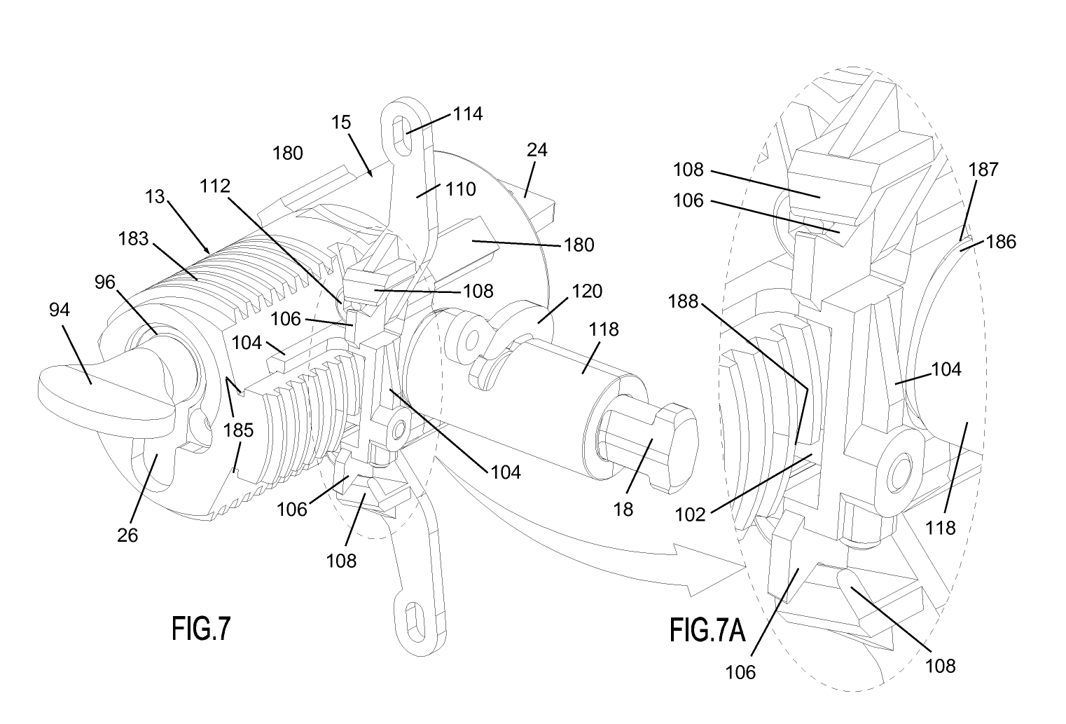

Referring again to FIGS. 5A and 6A, a door handle biaser 83 is mounted on portion 54A of the handle, and may be prevented from moving off portion 54A with a retaining clip or circlips 85. Door handle biaser 83 has a pair of ears 89. In the inner escutcheon 84 (FIG. 5A), ears 89 are biased by a pair of biasing devices, such as coil springs 91. Intermediate members 90 may be placed between ears 89 and the ends of springs 91. Intermediate members 90 may help distribute the spring force of springs 91 over the full contact area of ears 89 and ensure that springs 91 remain in biasing arrangement with ears 89. In the inner escutcheon 84 (FIG. 5A), ears 89 are constrained and limited in movement to abut against abutments 92. In the outer escutcheon 86 (FIG. 6A), ears 89 are constrained and limited in movement to abut against abutments 93. Escutcheons 84 and 86 are each formed with an aperture 94 (FIGS. 5 and 6) for cylinder lock 26 and outer housing 15 (FIG. 1A) and inner housing 13 (shown in FIG. 7).

Reference is now made to FIGS. 7 and 7A, which illustrate cylinder lock 26, which, without limitation, may be a double Euro-profile cylinder lock that has a plug (outer plug), which can be turned by key 24, and another plug 96 (inner plug) by a knob 94 (alternatively, could also be key operated). Cylinder lock 26 is housed in outer housing 15 and inner housing 13. Outer housing 15 is formed with lugs 180 which are arranged to be received in channels 181 formed in tapped bosses 182 around the aperture 94 of outer escutcheon 86 (FIG. 6A). This serves to prevent rotation of outer housing 15 upon installation in the door (and of course prevents rotation of inner housing 13 as well, since it is secured to outer housing 15), and also prevents a vandal from trying to forcefully pull the housing outwards. Inner housing 13 is formed with external threads 183 on part of its periphery, which mate with complementary internal threads 184 formed on aperture 94 of inner escutcheon 84 (FIG. 5). This enables accurately positioning inner housing 13 (and of course outer housing 15, too) in the door (not shown), at the fine intervals of the threads. This likewise prevents a vandal from forcefully pulling out the housings.

Rotation of either plug of cylinder lock 26 operates a modified cam 97 (FIGS. 9A and 9B), which is known from U.S. Pat. No. 7,343,763 and US Patent Application 20090031769 to Dolev.

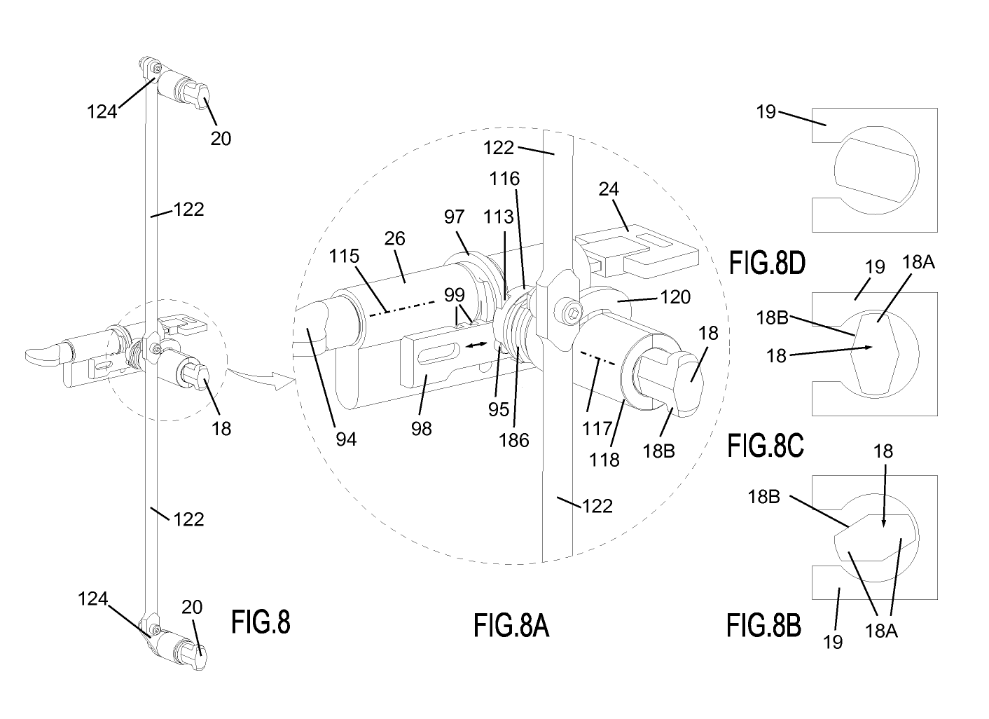

Basically, as seen in FIGS. 8A, 9A and 9B, cam 97 is a helical cam. A linear actuator 98 has threads 99 (FIGS. 8A and 9A) formed thereon that mesh with the helical threads of helical cam 97. When cylinder lock 26 is operated by rotating key 24 (or knob 94) (FIG. 7), linear actuator 98 moves linearly a longitudinal axis 115 of the cylinder lock 26 (FIG. 8A), thus converting rotational motion to axial motion. As seen in FIG. 7, slider 104 slides along grooves 185 formed in inner housing 13. As seen in FIG. 8A, deadbolt 18 is journaled in a housing 118, and an end 116 of deadbolt 18 is formed with grooves 113. Housing 118 may be made of two halves which terminate in annular grooves 186 that enter a hole 187 formed with grooves (FIG. 7A) formed at the junction of inner and outer housings 13 and 15. This connection prevent pulling out housing 118 from the housings. Making housing 118 of two halves may facilitate assembly, since end 116 may be larger in diameter than housing 118. Linear actuator 98 has a pin 95 that is arranged to enter any one of grooves 113. Thus, as linear actuator 98 moves linearly, the actuation of pin 95 engaging the end 116 of deadbolt 18 causes rotation of deadbolt 18. Thus, rotation of cam 97 about longitudinal axis 115 of the cylinder lock 26 rotates deadbolt 18 about a rotational axis 117 generally perpendicular to longitudinal axis 115. It is noted that rotational axis 117, in alternate embodiments, is not necessarily perpendicular to longitudinal axis 115; in general, rotational axis 117 is different from than longitudinal axis 115. For example, rotational axis 117 is not collinear with and is not parallel to longitudinal axis 115. However, in an alternate embodiment, rotational axis 117 can be parallel to longitudinal axis 115.

It is noted that the conversion of rotation about longitudinal axis 115 of the cylinder lock 26 to rotation of deadbolt 18 about axis 117 can be accomplished with other mechanisms. For example, the cam 97 can be a bevel gear which meshes with another bevel or worm gear. Twisted belt pulleys can also be used, for example.

The present invention, however, provides structure not shown or taught in U.S. Pat. No. 7,343,763 and US Patent Application 20090031769. As is now described, one inventive feature includes retraction of the latch as the deadbolt is rotated. Another feature includes rotation of the deadbolt simultaneously rotating auxiliary deadbolts.

Reference is now made to FIGS. 9A and 9B. Linear actuator 98 is formed with a slot 100, in which a dowel 102 of a slider 104 is received. Dowel 102 also passes through a slot 188 formed in inner housing 13, as seen in FIG. 7A. Slider 104 is formed at opposite ends thereof with linear cams 106. Linear cams 106 are arranged to slide against a cam follower 108 formed on a latch actuator 110 (seen best in FIG. 7A). Latch actuator 110 is arranged to pivot about a pivot 112, and is formed with a slot 114 at an end opposite to cam follower 108. Pivot 112 may be a screw which is one of three fasteners that attach the inner housing 13 with the outer housing 15 (the third fastener not seen in the drawings). Slot 114 receives therein pin 66 of latch 16 (FIG. 9B). As mentioned before, rotation of cam 97 causes linear actuator 98 to move longitudinally parallel to longitudinal axis 115 of the cylinder lock 26. This causes linear cam 106 to move against cam follower 108, which in turn causes latch actuator 110 to pivot about pivot 112, and causes slot 114 to press against pin 66 and retract latch 16 to an unlatched position that permits opening the door. It is noted that slot 100 is elongate (not a simple round hole). This ensures that slider 104 starts to slide only after deadbolt 18 has been turned to the unlocked position.

It is noted that rotation of cam 97 rotates deadbolt 18 from a locked position with respect to a (for example, C-shaped) bolt receptacle 19 (installed in the doorpost), shown in FIG. 8C, to an unlocked position, shown in FIG. 8B, while continuing to retract latch 16, too. In the illustrated embodiment, cam 97 is always operatively connected to deadbolt 18 throughout retraction of latch 16. This means that after deadbolt 18 has reached the unlocked position, it continues to rotate during retraction of latch 16. It is further noted that deadbolt 18 includes two protrusions 18A with sloping side faces 18B. The structure of sloping side faces 18B allows deadbolt 18 to rotate an extra amount while latch 16 is retracted and yet remain in the gap of bolt receptacle 19, which is an unlocked state.

In contrast, in FIG. 8D, if the deadbolt were not to have sloped side faces, the deadbolt would continue to rotate after unlatching the latch and rotate back into a blocked position (the non-sloped face cannot pass to the left out of bolt receptacle 19).

As seen in FIGS. 8 and 8A, rotation of deadbolt 18 also rotates an arm 120, which is connected to push-pull bars 122 (or rods, the shape can be anything), which in turn are connected to auxiliary deadbolts 20 via arms 124 (it is noted that auxiliary deadbolts 20 also have sloping sides like deadbolt 18). Thus, rotation of deadbolt 18 simultaneously rotates auxiliary deadbolts 20.

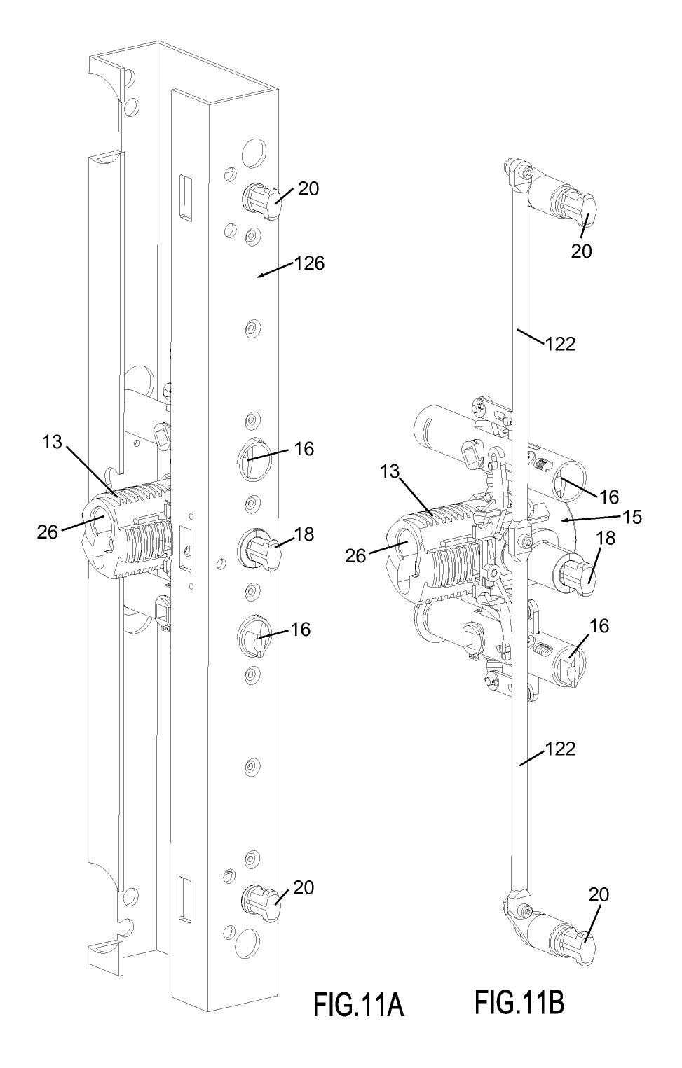

Reference is now made to FIGS. 11A and 11B. The entire assembly of the inner and outer housings 13 and 15 of cylinder lock 26, deadbolt 18, latches 16 and auxiliary deadbolts 20 may make up a lock assembly, which is housed in a casing 126.

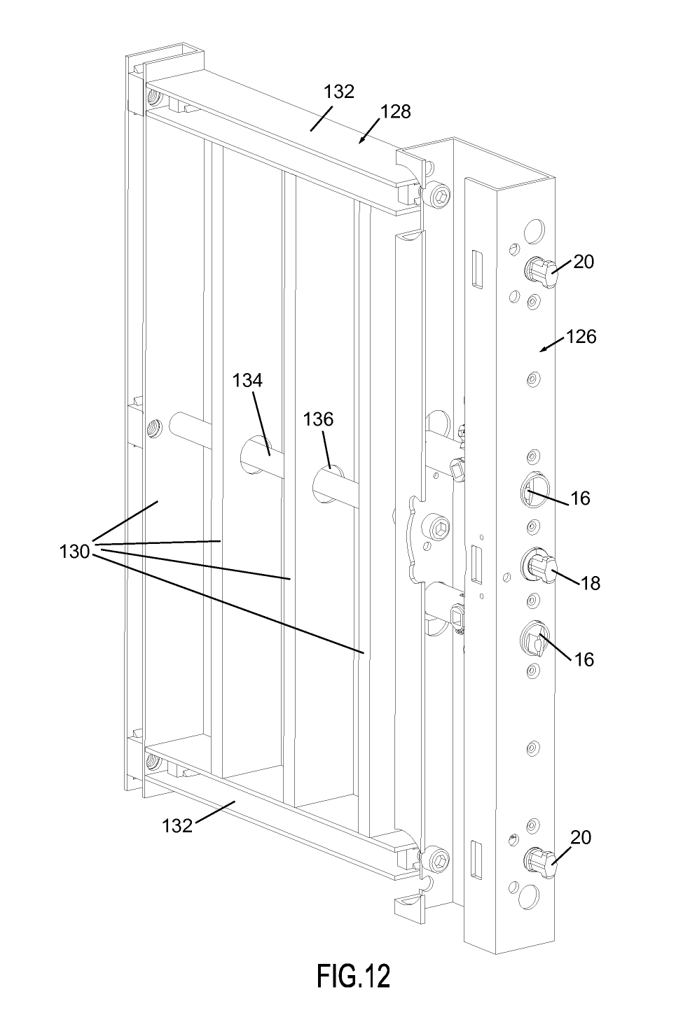

It is noted that standard mortise locks of the prior art are installed through an opening (called a mortise) in the edge of the latch-side of the door. This opening weakens the door strength, both for wooden and metal doors; worse, it weakens the door precisely in one of the places vandals attempt to pry open the door. In contrast, in the present invention, the lock assembly is installed in casing 126 which is installed either through the top or bottom opening of the door construction assembly 128. No critical areas of the door are weakened. The casing 126 may have a C-shape or any other robust shape with excellent strength. Casing 126 may be fixed to a door construction assembly 128 (FIG. 12). Alternatively, the casing 126 may be installed on the outside of the door skin. The upper and lower rails of the door frame, described below with reference to FIG. 12, transfer any vandalizing forces on the door skin into the door posts. Thus, even with a thin door skin, the door assembly of the present invention is very strong and resistant to attack. The door skin is like a thin membrane fixed at its sides; any blows to the door skin are easily absorbed into the door posts and the door skin deflects like a drum skin without damage.

Reference is now made to FIG. 12. Door construction assembly 128 includes stiles 130, upper and lower rails 132 and a central rail 134, which may be a massive bar which passes through apertures 136 formed in stiles 134. The upper and lower rails 132 may be constructed as horizontal U-channels. Any number of stiles and rails may be used. Reference is now made to FIGS. 13 and 13A. Each of the hinge-side ends of the 132 and 134 is secured to a plate 138 (installed in the wall behind the doorpost) of a hinge assembly 140, which includes a wall anchor 142 for robust installation in a wall. The deadbolt 18 and auxiliary deadbolts 20 interface with locking receptacles 144 (installed in the wall behind the doorpost) on the latch side of the door. Locking receptacle 144 includes a wall anchor 146 for robust installation in a wall. In this manner, the locking system of the present invention locks the door with high security and high resistance to pull-out attempts and other kinds of violent vandalism.

What is claimed is:

1. A lock assembly comprising:
a cylinder lock comprising a plug and cam which are both rotatable about a longitudinal axis of said cylinder lock; and
a latch and a rotatable deadbolt both operatively linked to said cam, wherein rotation of said cam about said longitudinal axis causes two actions: rotation of said deadbolt about a rotational axis different from said longitudinal axis to move said deadbolt to an unlocked position, and retraction of said latch to an unlatched position.

2. The lock assembly according to claim 1, wherein said deadbolt is operatively connected to one or more auxiliary deadbolts, wherein rotation of said deadbolt simultaneously rotates said auxiliary deadbolts.

3. The lock assembly according to claim 1, wherein rotation of said cam about said longitudinal axis causes rotation of said deadbolt about said rotational axis to move said deadbolt to the unlocked position, and afterwards, further rotation of said cam about said longitudinal axis causes retraction of said latch to the unlatched position, with said deadbolt remaining in the unlocked position.

4. The lock assembly according to claim 3, wherein said deadbolt comprises protrusions with sloping side faces, and wherein after said further rotation of said cam that causes retraction of said latch to the unlatched position, said sloping side faces of said deadbolt remain in the unlocked position.

5. The lock assembly according to claim 1, wherein said cylinder lock is installed in an inner housing and an outer housing.

6. The lock assembly according to claim 1, wherein said cam is operatively connected to a linear actuator that is operatively connected to a latch thrower which is operatively connected to a latch, wherein rotation of said cam about said longitudinal axis causes linear movement of said linear actuator which moves said latch thrower to retract said latch, and wherein said linear actuator is operatively connected to said deadbolt to cause rotation of said deadbolt.

7. The lock assembly according to claim 1, wherein said rotational axis is generally not parallel to said longitudinal axis.

8. The lock assembly according to claim 5, wherein said inner and outer housings, said deadbolt, said latch and said auxiliary deadbolts are housed in a casing.

9. The lock assembly according to claim 8, wherein said casing is attached to a door construction assembly that comprises stiles, and rails, and wherein each hinge-side end of said rails is secured to a hinge assembly, which comprises a wall anchor, and said deadbolt and said one or more auxiliary deadbolts interface with locking receptacles, which comprise wall anchors.

10. The lock assembly according to claim 1, wherein said lock assembly is symmetrically installed in a door, wherein a center of said lock assembly is equidistant to a top and a bottom of said door.

11. The assembly according to claim 10, wherein an adjustable door insert assembly is installed said door, said adjustable door insert assembly comprising bristles mounted on a rod, said rod sitting in an elongate opening formed in bearing supports, wherein said bristles are movable up and down as the door is opened or closed.

12. The assembly according to claim 11, further comprising inner and outer door handles and a spindle which is adjustable to one of two positions, where in one position, said spindle is operatively connected to both said inner and outer door handles, and in another position, said spindle is moved linearly so that it is not in operative connection with said outer door handle.

13. The assembly according to claim 10, wherein said door is configurable for both right sided and left sided installations.

14. The assembly according to claim 1, comprising two latches and a double door handle which operates both of said latches by moving said double door handle in either of up or down directions.

15. The assembly according to claim 6, wherein said latch thrower is operative to retract said latch with a rotation of only about 30° in any direction.
